(19) United States
(12) Patent Application Publication
(10) Pub. No.: US 2005/0284520 A1
(43) Pub. Date: Dec. 29, 2005

(54) Common damper hub for valve bodies

(76) Inventors: Robert P. Carlstedt, Rochester Hills, MI (US); James J. Siesel, Canton, MI (US); Christopher T. Sledz, Armada, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/876,135

(22) Filed: Jun. 24, 2004

(51) Int. Cl. F16K 17/18

(52) U.S. Cl. 137/493

(57) ABSTRACT

A piston valve assembly for a damper comprises a piston having a central hole and a fluid passageway spaced from the hole. A deflection disc having a central aperture is aligned with the hole. The deflection disc is arranged adjacent to the piston and at least partially blocks the fluid passageway for regulating the flow of hydraulic fluid between the fluid chambers when installed in the damper. A hub, common across different dampers, includes a neck that is arranged in the hole and the aperture of the deflection disc. A retainer abuts an unthreaded outer surface of the hub. During assembly, the retainer is received on the cylindrical outer surface in a slip fit relation. The deflection disc and pistons are loaded to a predetermined clamp load. The retainer is secured to the outer surface by a securing material such as a weld bead.

### BACKGROUND OF THE INVENTION

This invention relates to dampers such as vehicle suspension shock absorbers, struts and the like. More particularly, the invention relates to a common hub design for piston and base valve arrangements enabling a more modular damper.

Dampers such as shock absorbers and struts are used in vehicles to absorb inputs from the roadway to provide a desirable vehicle ride. Typically, vehicle dampers employ a piston that moves through a cylinder having hydraulic fluid. The fluid flows through fluid passageways and valves in the piston, which absorbs the roadway inputs in the form of heat. The piston size, valves, and piston rod are selected based upon the particular vehicle and vehicle application, which requires the damper OEM to stock numerous parts for different vehicles and even for different suspension packages for the same vehicle.

One common type of piston valve assembly uses deflection discs on either side of the piston. The deflection discs at least partially block the fluid passages in the piston to regulate the fluid flow rate through the passages during the compression and rebound strokes of the damper. The number, size and thickness of the discs are selected to provide a desired ride characteristic for the vehicle, such as the firmness of the suspension. The OEM may stock over one hundred different deflection discs for different dampers. The same is true of other valve bodies such as base valves in twin tube shock absorbers.

The piston and deflection discs are secured in abutment with one another by the piston rod and nut. The rod includes a shoulder with a neck extending from the shoulder to support the piston and deflection discs. An end of the neck is threaded to receive the nut. The nut is tightened onto the rod to a predetermined torque so that the deflection discs are held securely against the piston. The damping characteristics of the damper are adversely affected if the deflection discs are not properly loaded against the piston. The load on the deflection discs may decrease even after the predetermined torque has successfully been achieved and the damper has passed the final test. Therefore, what is needed is a more modular damper design that reduces the number components stocked for different dampers. Also, what is needed is a more modular damper design that provides more consistent loading of the piston valve assembly.

### SUMMARY OF THE INVENTION AND ADVANTAGES

The present invention provides a piston valve assembly for a damper comprising a piston having a central hole and a fluid passageway spaced from the hole. A deflection disc having a central aperture is aligned with the hole. The deflection disc is arranged adjacent to the piston and at least partially blocks the fluid passageway for regulating the flow of hydraulic fluid between the fluid chambers when installed in the damper. An inventive hub includes a neck that is arranged in the hole and the aperture of the deflection disc. The hub is common between different piston valve assemblies. A retainer abuts an unthreaded outer surface of the hub. Said another way, a line parallel to a hub axis extends along the outer surface and lies in a plane tangential to the outer surface. In one example embodiment, the outer surface is cylindrical in shape having a smooth surface. During assembly, the retainer is received on the cylindrical outer surface in a slip fit relation. The retainer is secured to the outer surface by a securing material such as a weld bead. The same configuration maybe used for a base valve.

The hub is an additional component of the piston valve assembly not found in the prior art. The retainer is received in a slip fit relationship on the hub and then welded thereto providing the load on the deflection disc to maintain the desired loading throughout the operation of the piston valve assembly. The hub is also common across different dampers and may receive different sized pistons and deflection discs so that the piston valve assembly may be used in different dampers.

The inventive piston valve assembly is manufactured using an inventive method of manufacturing. The method of manufacturing comprises the steps of providing the inventive hub and installing a deflection disc and piston on the hub. Of course, multiple deflection discs using various configurations may be arranged on either side of the piston. The deflection disc and pistons are loaded to a predetermined clamp load. A retainer is placed on the hub in a slip fit relationship thereto and secured to the hub while the deflection disc and pistons are maintained under the predetermined clamp load. The retainer is secured to the hub, for example, by welding.

Accordingly, the above mentioned provides a modular damper design that reduces the number of components stocked for different dampers while providing consistent loading of the piston valve assembly.

### BRIEF DESCRIPTION OF THE DRAWINGS

Other advantages of the present invention can be understood by reference to the following detailed description when considered in connection with the accompanying drawings wherein:

FIG. 1 is a side elevational view of a fully assembled damper manufactured according an inventive manufacturing process for the inventive piston valve assembly;

FIG. 2 is a cross-sectional view of an inventive piston valve assembly including a common inventive hub;

FIG. 3 is a cross-sectional view of the inventive piston valve assembly having floating compression and rebound deflection discs;

FIG. 4 is a cross-sectional view of the inventive piston valve assembly having a floating compression deflection disc and a fixed rebound deflection disc;

FIG. 5 is a cross-sectional view of the inventive piston valve assembly having fixed compression and rebound deflection discs with a fixed stop on the compression side and a spring loaded biasing member on the rebound side;

FIG. 6 is a cross-sectional view of the inventive piston valve assembly having fixed compression and rebound deflection discs and stops on the compression and rebound sides;

FIG. 7 is a base valve for a twin tube shock absorber using the inventive hub;

FIG. 8 is a cross-sectional view of a base valve using the inventive hub;

FIG. 9 is a cross-sectional view of the inventive piston valve assembly arrangement similar to that shown in FIG. 6 suited for a monotube shock absorber;

FIG. 10 is a cross-sectional view of an inventive piston valve assembly with an electric valve assembly as the inventive hub;

FIG. 11 is a cross-sectional view of the inventive hub providing an anti-topping feature; and

FIG. 12 is a cross-sectional view of the inventive piston valve assembly attached to a hollow rod incorporating a conventional anti-topping feature.

### DETAILED DESCRIPTION OF THE PREFERRED EMBODIMENT

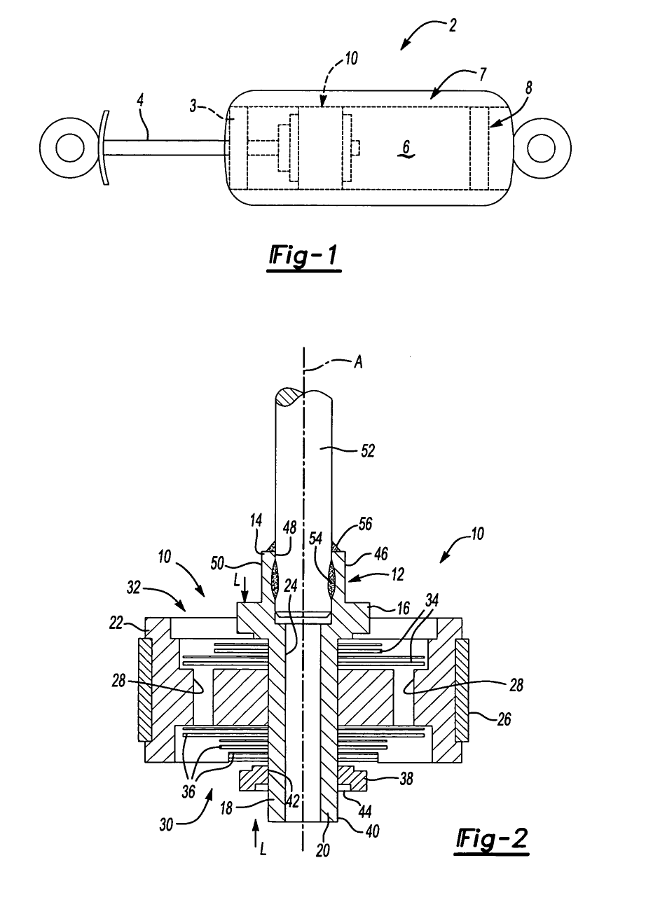

A twin tube shock absorber 2 is shown in FIG. 1. The shock absorber 2 schematically depicts a cylinder head 3 at one end slidingly receiving a rod 4, as is well known in the art. An end of the rod 4 is secured to the inventive piston valve assembly 10, which is arranged in a fluid chamber 6. During a compression stroke, the piston valve assembly 10 moves towards a base valve 8, which regulates the flow of fluid from the fluid chamber 6 to an outer chamber 7. As will be appreciated from the description below, the piston assembly 10 and base valve 8 incorporate an inventive hub 12, which is shown in FIGS. 2-12.

A piston valve assembly 10 of the present invention is shown in FIG. 2. The assembly 10 includes an inventive hub 12 that is designed to be used with different sized pistons and deflection discs to facilitate a more modular damper assembly. The hub 12 includes a first end 14 that is adapted to receive a piston rod. The first end 14 includes a shoulder 16 and a neck 18 extending from the shoulder 16 to a second end 20.

A piston 22 having a hole 24 is installed onto the hub 12 with the neck 18 received in the hole 24. Different sized pistons may be used on the same hub, for example, 25 mm, 30 mm, or 35 mm diameter pistons having the same sized central hole 24 could fit on the same hub. The neck 18 has a generally uniform cylindrical circumference along its length. The piston 22 includes an outer circumference 26 that engages the inner wall of the damper cylinder, as is well known in the art, when the damper is assembled.

The piston 22 includes one or more fluid passages 28 extending between compression 30 and rebound 32 sides of the piston 22. One or more compression deflection discs 34 are arranged on the rebound side 32 of the piston, and one or more rebound deflection disc 36 are arranged on the compression side 30 of the piston 22. The discs 34 and 36 include a central aperture that receives the neck 18. The discs 34 and 36 regulate the fluid flow through the fluid passages 28 to provide a desired damping characteristic as the piston valve assembly 10 moves through the fluid chambers and the damper. The discs 34 and 36 deflect upward and away from the sides 32 and 30 as the fluid within the fluid passage 28 exerts pressure on the discs 34 and 36, as is well known in the art. If the discs 34 and 36 are not firmly retained against the piston 22, the discs 34 and 36 will open under lower pressures resulting in undesired damping characteristics.

The neck 18 includes an outer surface 40. The surface 40 is preferably smooth, cylindrical, and unthreaded. The surface 40 has a line extending along a length parallel to a hub axis A. The line lies in a plane tangential to the outer surface. A retainer 38 includes a portion having a generally cylindrical inner surface 42 that is received in a slip fit relationship on the outer surface 40 of the neck 18.

The piston 22 and retainer 38 are loaded to a predetermined clamp load L to force the discs 34 and 36 firmly into abutment with the piston 22, shoulder 16 and retainer 38, in the example shown. While the assembly 10 is maintained under a predetermined clamp load L, a securing material 44 is used to secure the retainer 38 to the neck 18. The securing material 44 may be a weld bead. At this point in the piston valve assembly manufacturing process, a completed sub-assembly is provided.

Different size piston rods may be installed onto the assembly 10. To achieve this modularity in design, the hub 12 includes a collar 46 extending from the shoulder 16. The collar 46 includes an inside surface 48 and an outside surface 50. A solid rod 52, for example 12 mm in diameter, may be received in the collar 46 in close fitting relationship to the inside surface 48. The rod 52 may be impulse welded to the inside surface 48 forming a weld bead 54. The rod 52 may also be laser welded forming a weld bead 56 about the circumference of the rod 52 where it meets the collar 46 to form a seal past which fluid will not leak.

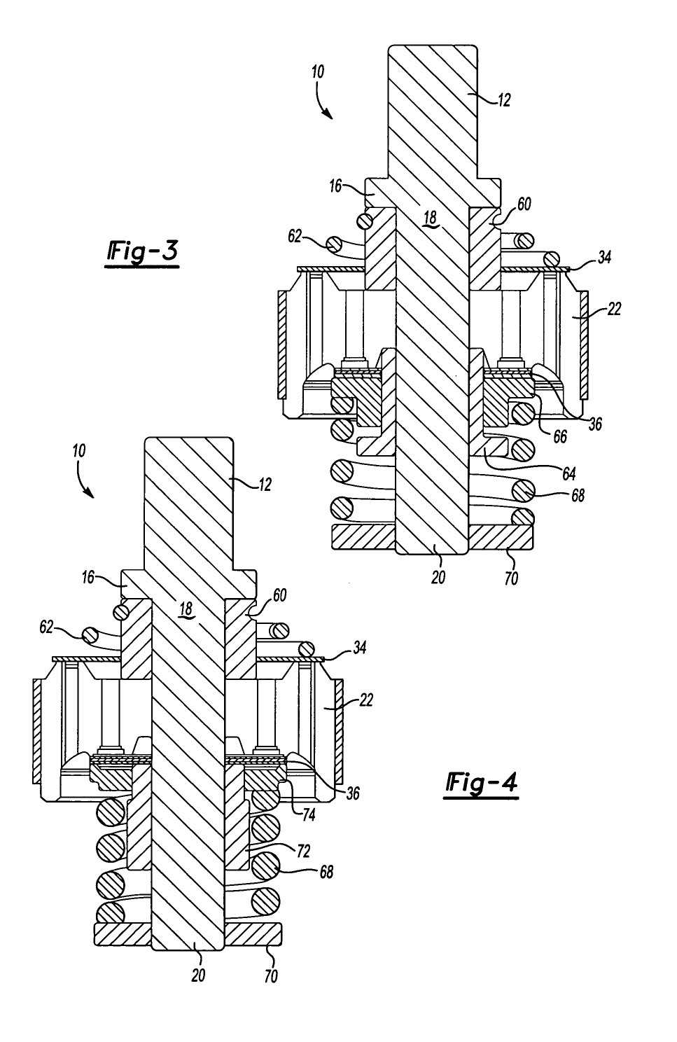

As will be appreciated from the description of FIGS. 3-12, the inventive common hub 12 may be used in any number of configurations of piston valve assemblies 10 or base valves 8. Referring to FIG. 3, a floating-floating disc arrangement is shown in which the discs in their entirety are permitted to move axially along the axis provided by the hub 12. A spring retainer 60 supporting an end of a spring 62 is received on the neck 18 and is in an abutting engagement with the shoulder 16. The spring 62 biases the compression deflection disc 34 into engagement with the piston 22. The spring retainer 60 also acts as a guide upon which the deflection discs 34 may move axially relative thereto. Another guide 64 is arranged on the neck 18 opposite the guide 60 retaining the piston 22 between the guide 60 and 64. The guide 64 is secured to the neck 18, for example, by welding. A plate 66 is arranged adjacent to the rebound disc 36 and is slidable relative to the guide 64. A flange extending outwardly from an end of the guide 64 acts as a rearward stop for the plate 66 as the rebound deflection discs 36 move away from the piston 22.

A retainer 70 is secured to an end 20 of the neck 18, in the same manner described above relative to FIG. 2, to capture a spring 68 between the plate 66 and retainer 70. The inventive hub 12 and retainer 70 arrangement provides the unique advantage of enabling a preload to be used to load the spring 68 to a desired spring load prior to securing the retainer 70 to the end 20. Similar to the clamp load applied in FIG. 2, the end of the hub 12 is retained and the retainer 70 is loaded to achieve the desired spring load 68, which enables variation in spring loads due to tolerance stack-ups experienced in manufacturing the piston valve assembly to be eliminated. Once the desired spring load on the spring 68 is achieved, the retainer 70 is welded to the hub 12.

The piston valve assembly 10 shown in FIG. 4 is similar to that shown in FIG. 3, except that the rebound side includes a fixed disc relationship. Specifically, the rebound discs 36 are captured between a guide 72 such that the deflection discs 36 are axially fixed at the inner periphery. A plate 70 is slidingly received on the guide 70, and the spring 68 is captured between the retainer 70 and plate 74. The spring 68 is loaded to a desired spring load and the retainer 70 secured to the hub 12, as described above.

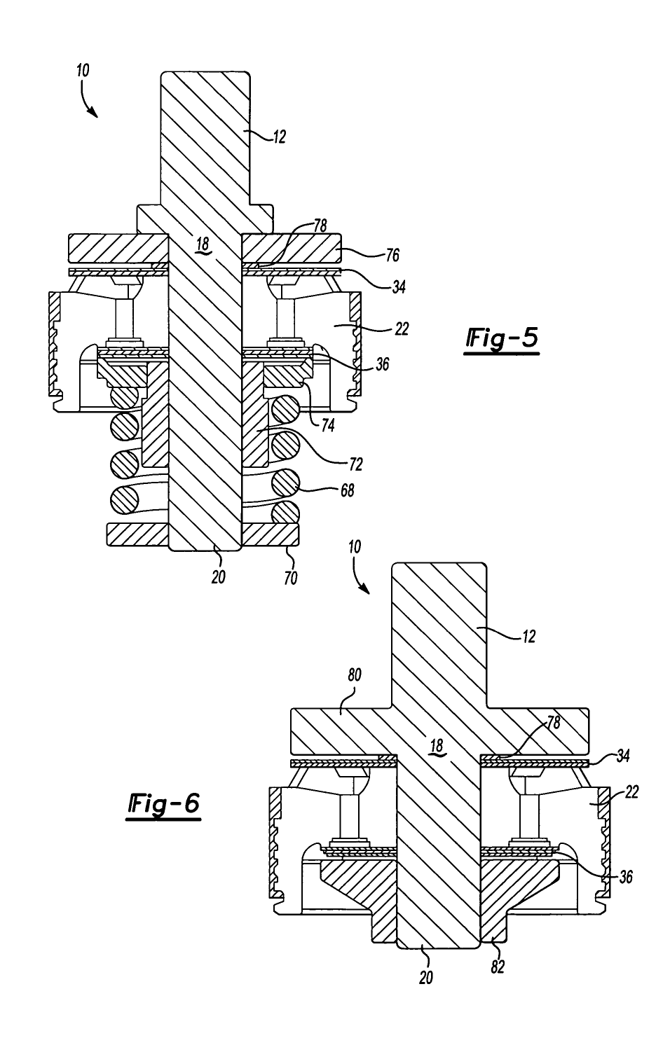

FIG. 5 depicts a piston valve assembly similar to that shown in FIG. 4, except the compression side includes a fixed disc configuration. The hub 12 includes a shoulder having the same diameter as the shoulder 16 shown in FIGS. 2-4. However, the piston valve assembly 10 additionally includes a stop 76 arranged between the shoulder 16 and piston 22. A spacer 78 is arranged between the stop 76 and compression discs 34 so that the compression discs 34 pivot about the spacer 78 until they engage the stop 76. The stop 76 need not be affixed or welded to the hub 12. However, if the stop 76 is welded to the hub 12, it may also provide an anti-topping feature protecting the piston valve assembly from damaging collision with the shock absorber body, which will be better appreciated in connection with the description relative to FIG. 11 below.

FIG. 6 depicts a piston valve assembly 10 having a fixed compression and rebound disc configuration. The separate stop 76 shown in FIG. 5 is incorporated into a shoulder 80 extending radially from the hub 12. The retainer 82 is installed and loaded onto the hub 12 in the same manner described relative to FIG. 2. The retainer 82 also acts as a stop between the rebound disc 36.

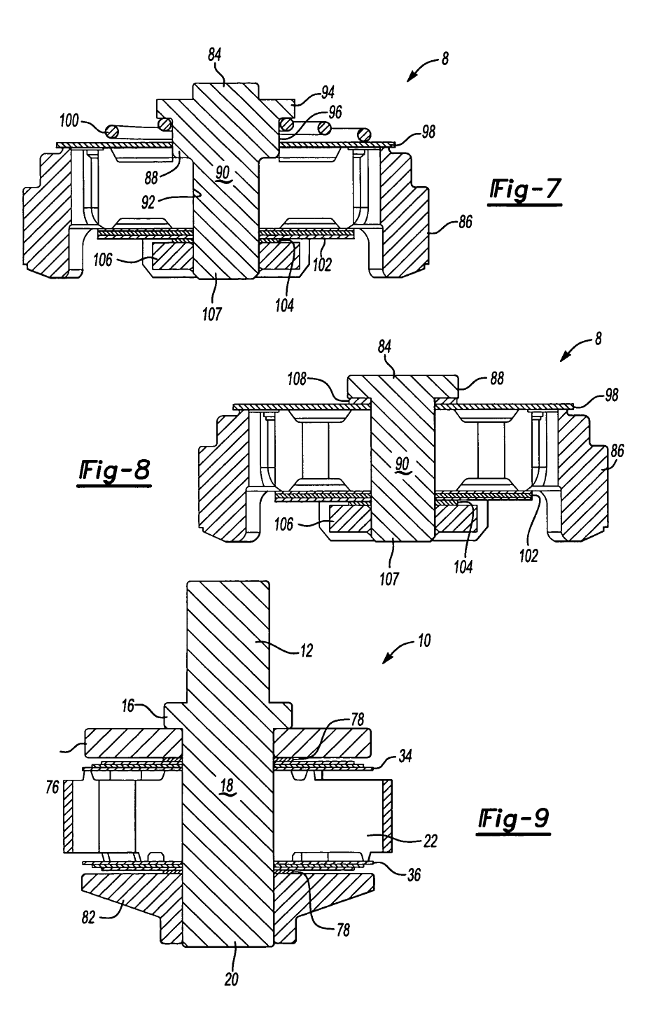

FIGS. 7 and 8 show the inventive hub 84 for use with base valves 8. Similar to the hubs 12 used in piston valve assemblies 10, the hubs 84 are common and may be used with numerous other components to reduce the inventory of base valve components.

Referring to FIG. 7, the hub 84 includes a base valve head 86 received by a neck 90 of the hub 84. The head 86 abuts a hub shoulder 88. A guide 94 extends radially from the hub 84 and is spaced axially from the shoulder 88 away from the head 86. A spring 100 is arranged between the spring retainer 94 and rebound deflection disc 98 biasing the deflection disc 98 with the head 86. On the compression side, a retainer 106 is preloaded and secured to the hub 84 in the manner described relative to FIG. 2. Compression disc 102 engages the head 86, and a spacer 104 is arranged between the compression deflection disc 102 and the retainer 106.

The base valve 8 shown in FIG. 8 uses a fixed rebound disc arrangement so that the hub 84 does not need the spring retainer shown in FIG. 7. A spacer 108 is arranged between the shoulder 88 and rebound discs 98.

The piston valve assemblies 10 shown in FIGS. 2-6 are preferably used in twin tube shock absorber arrangements. The piston valve assembly 10 shown in FIG. 9 is preferably used in a monotube shock absorber arrangement. The assembly 10 uses a configuration on the compression side similar to that shown in FIG. 5 and a configuration on the rebound side similar to that shown in FIG. 6. Monotube piston valve assemblies typically differ from twin tube piston valve assemblies in that they typically have a larger diameter and increased flow capabilities through the piston 22.

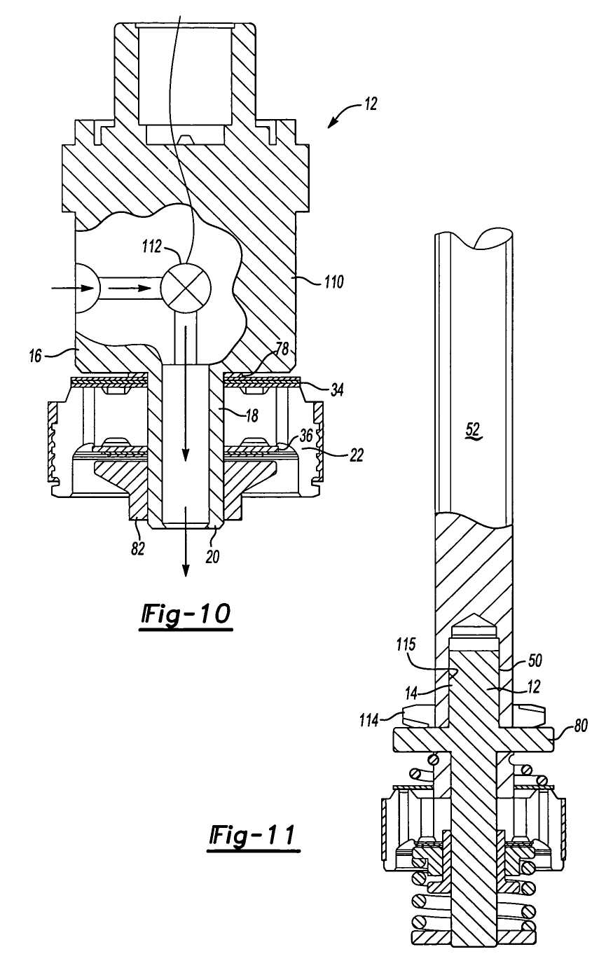

In FIG. 10, the inventive hub 12 is provided by an electric valve housing 110 having an electrically operated valve 112 located within. A hollow rod (not shown) is secured to the end of the electric valve housing 110 to carry wires to the valve 112. The electric valve housing 110 provides a shoulder 16 at its base and includes a neck 18 extending through the piston 22. A retainer 82 is secured to the end 20 of the neck 18 in the same manner as described relative to FIG. 2.

FIG. 11 depicts an alternative rod attachment configuration to that shown in FIG. 2. The end 14 of the hub 12 is received in a hole 115 in the rod 52. The rod 52 is secured to the hub 12 in the manner described relative to FIG. 2. The hub 12 includes an enlarged shoulder 80 for providing an anti-topping feature. Piston valve assemblies are susceptible to damage when moving rapidly to a fully extended position. In the fully extended position, the piston valve assembly may collide violently with a portion of the shock body, such as the cylinder head 3 damaging the piston and/or its valve components. By using an enlarged shoulder 80 or a stop 76 (shown in FIGS. 5 and 9) relative to the hub 12, the piston valve and its components can be isolated from any damaging vibrations by directing the forces into the hub 12. A bumper 114 may be arranged on the hub 12 to absorb the impact.

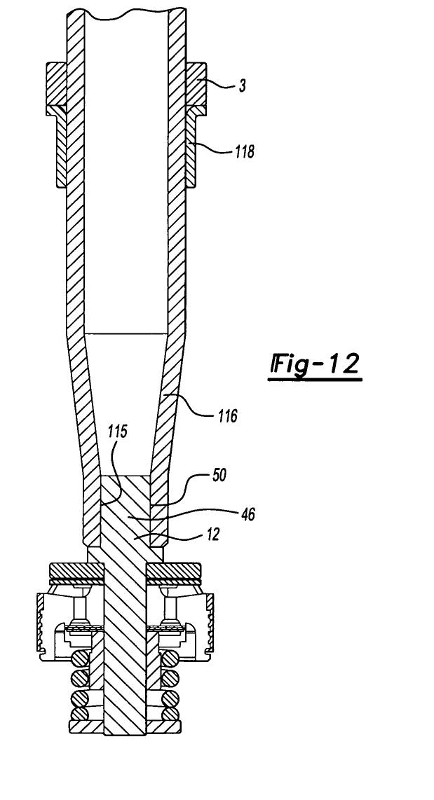

A hollow rod may also be used with the common inventive hub 12, as shown in FIG. 12. The hole in the rod 115 is secured to the outside surface of the hub 12 provided by the collar 46 in the manner described relative to FIG. 2. FIG. 12 also illustrates a conventional stop 118 used as an anti-topping feature for absorbing an impact on full extension with the cylinder head 3. However, the conventional stop 118 requires a separate component secured to the rod 116 and an additional welding operation.

Referring to FIG. 12, a different sized rod, for example 22 mm in diameter, may be secured to the same hub 12 as shown in FIG. 2, which included a solid rod 52. The larger diameter rod is typically a hollow rod 116. The hollow rod 116 is installed onto the collar 46 such that an inside surface of the rod 115 is in close fitting relationship with the outside surface 50. Similar to the assembly shown in FIG. 2, the rod 116 is impulse welded to the collar forming a weld bead 60, and the rod 58 may also be laser welded to the collar 46 forming a laser weld bead 62 about the circumference of the rod 58 where it meets the collar 46, which is shown in detail in FIG. 2.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A method of manufacturing a damper comprising the steps of:
a) providing a hub;
b) installing a deflection disc and valve body on the hub;
c) axially sliding a retainer onto the hub;
d) loading the deflection disc to a predetermined clamp load; and
e) securing the retainer to the hub with the deflection disc under the predetermined clamp load to provide a valve assembly.

2. The method according to claim 1, wherein step b) includes arranging a guide between a hub shoulder and a piston, the guide supporting a spring biasing a second deflection disc toward the valve body.

3. The method according to claim 1, wherein step b) includes securing a guide to the hub with the guide abutting the valve body.

4. The method according to claim 3, wherein step b) includes capturing a plate between the guide and deflection disc, the plate movable axially relative to the guide, the plate applying a biasing force to the deflection disc.

5. The method according to claim 4, wherein step d) includes loading a spring arranged between the plate and retainer to the predetermined clamp load corresponding to a predetermined spring load.

6. The method according to claim 4, wherein the deflection disc is axially retained between the valve body and the guide.

7. The method according to claim 1, wherein the valve body is one of a piston and a head.

8. The method according to claim 1, wherein step b) includes arranging a spacer between the deflection disc, and the retainer, and defining a gap between the retainer and the deflection disc.

9. The method according to claim 1, comprising securing a rod to the hub by impulse welding.

10. The method according to claim 1, wherein step d) includes forcing the retainer in an axial direction toward a shoulder on the hub.

11. The method according to claim 1, wherein step c) includes sliding the retainer in a slip-fit relation axially over the hub.

12. The method according to claim 11, wherein step e) includes laser welding the retainer to the hub.

13. A valve assembly for a damper comprising:
a valve body having a central hole and a fluid passageway spaced from said hole;
a deflection disc having a central aperture aligned with said hole, said deflection disc adjacent to said valve body and at least partially blocking said fluid passageway;
a hub having a neck disposed in said hole and said aperture; and
a retainer abutting an outer surface of said hub, said retainer secured to said outer surface by a securing material.

14. The valve assembly according to claim 13, wherein said hub includes a shoulder extending radially relative to said neck, and a rod secured to said hub proximate to said shoulder, said shoulder having a larger diameter than a diameter of said rod for isolating said valve body from topping forces.

15. The valve assembly according to claim 13, wherein said outer surface is a generally smooth outer cylindrical surface and said retainer includes a generally smooth inner cylindrical surface abutting said outer surface.

16. The valve assembly according to claim 15, wherein said securing material is a weld bead.

17. The valve assembly according to claim 13, wherein said valve body includes opposing sides with a deflection disc arranged adjacent to each of said opposing sides, one of said deflection discs arranged between a shoulder of said hub and said valve body and the other of said deflection discs arranged between said valve body and said retainer, said deflection discs having central apertures of the substantially the same diameter.

18. The valve assembly according to claim 13, wherein a rod is secured to said hub with a second material.

19. The valve assembly according to claim 18, wherein said second material is a weld bead.

20. The valve assembly according to claim 13, wherein said valve body is one of a piston and a base valve head.
